(19) United States
(12) Patent Application Publication
(10) Pub. No.: US 2008/0083451 A1
(43) Pub. Date: Apr. 10, 2008

(54) Solar energy system with spherical lens

(76) Inventors: Li-Hung Lai, Taichung (TW); Li-Wen Lai, HsinChu (TW); Wen-Sheng Hsieh, Taichung (TW); Li-Chieh Shih, Taichung (TW); Chia-Hung Lin, Taichung (TW); Kun-Fang Huang, Taichung (TW)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/543,199

(22) Filed: Oct. 5, 2006

(51) Int. Cl. H02N 6/00

(52) U.S. Cl. 136/246

(57) ABSTRACT

The invention relates to a solar energy system with spherical lens. The solar energy system comprises: a spherical lens and a solar energy plate. The spherical lens has a first surface and a second surface. The first surface is used for receiving incident light from a light source at any location. The second surface is used for transmitting concentrated light caused by the incident light to a predetermined region. The solar energy plate is mounted on the predetermined region, and is used for receiving the concentrated light and generating electrical energy. According to the invention, the spherical lens can receive the incident light from any location and transmit the concentrated light to the same predetermined region. The solar energy plate on the predetermined region can always receive the concentrated light from the spherical lens. Therefore, the efficiency of the solar energy system of the invention is high.

### BACKGROUND OF THE INVENTION

1. Field of the Invention

The present invention relates to a solar energy system, more particularly, a solar energy system with spherical lens.

2. Description of the Related Art

Referring to FIG. 1, it shows a first conventional solar energy system 10. The first conventional solar energy system 10 comprises: a lens 11 and a solar energy plate 12. The lens 11 is used for receiving sunlight 16 from the sun 18 and transmitting concentrated light 17. The solar energy plate 12 is used for receiving the concentrated light 17. By utilizing the lens 11, the area of the solar energy plate 12 can be decreased to save the space. However, the sun 18 is not always on the directly above position of the lens 11. If the sun 18 moves to the left side or right side of the solar energy plate 12, the solar energy plate 12 cannot receive the concentrated light 17 from the lens 11. The utilization rate of the first conventional solar energy system 10 is not good.

Referring to FIG. 2, it shows a second conventional solar energy system 20. The second conventional solar energy system 20 comprises: a lens 21, a solar energy plate 22 and a motor 23. The lens 21 is used for receiving sunlight 26 from the sun 28 and transmitting concentrated light 27. The solar energy plate 22 is used for receiving the concentrated light 27. Because of the above defect of the first conventional solar energy system 10, the second conventional solar energy system 20 utilizes the motor 23 for driving the lens 21 and the solar energy plate 22 to move following the movement of the sun 28. Therefore, the sun 28 is always on the directly above position of the lens 21, and the solar energy plate 22 can receive the concentrated light 27. However, the motor 23 will consume electrical energy, and decrease the total efficiency of the second conventional solar energy system 20.

Therefore, it is necessary to provide a solar energy system so as to solve the above problem.

### SUMMARY OF THE INVENTION

One objective of the present invention is to provide a solar energy system with spherical lens. The solar energy system comprises: a spherical lens and a solar energy plate. The spherical lens has a first surface and a second surface. The first surface is used for receiving incident light from a light source at any location. The second surface is used for transmitting concentrated light caused by the incident light to a predetermined region. The solar energy plate is mounted on the predetermined region, and is used for receiving the concentrated light and generating electrical energy.

According to the invention, the spherical lens can receive the incident light from any location and transmit the concentrated light to the same predetermined region. The solar energy plate on the predetermined region can always receive the concentrated light from the spherical lens. Therefore, the efficiency of the solar energy system of the invention is high.

### BRIEF DESCRIPTION OF THE DRAWINGS

FIG. 1 shows a first conventional solar energy system.

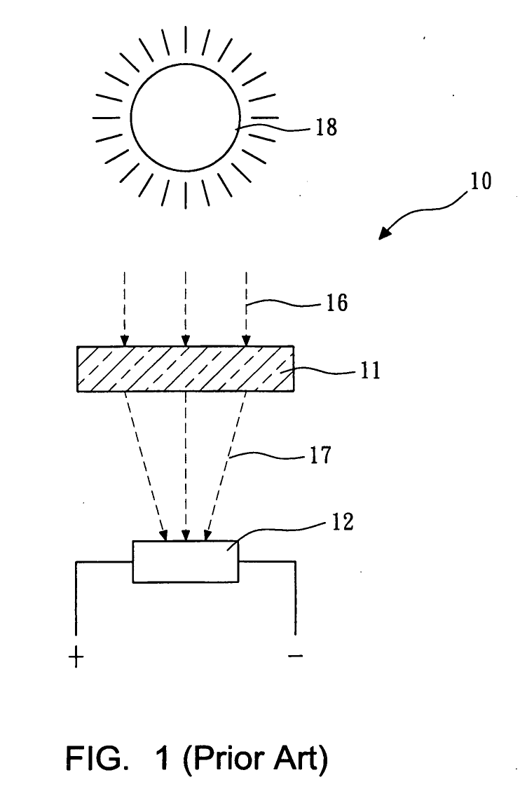

FIG. 2 shows a second conventional solar energy system.

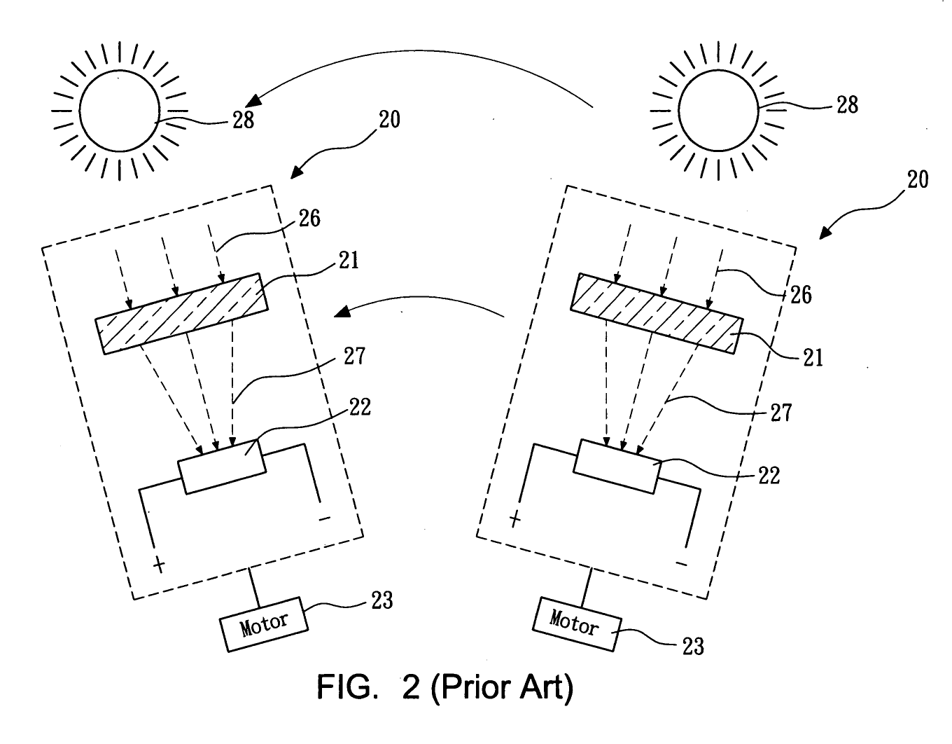

FIG. 3A shows a solar energy system with spherical lens, when the sun moves to the right side of the solar energy system, according to a first embodiment of the invention.

FIG. 3B shows the solar energy system with spherical lens, when the sun moves to the directly above position of the solar energy system, according to the first embodiment of the invention.

FIG. 3C shows the solar energy system with spherical lens, when the sun moves to the left side of the solar energy system, according to the first embodiment of the invention.

FIG. 3D shows the solar energy system with spherical lens, when the sun moves below the predetermined level, according to the first embodiment of the invention.

FIG. 4 shows a solar energy system with spherical lens on the night, according to a second embodiment of the invention.

### DETAILED DESCRIPTION OF THE INVENTION

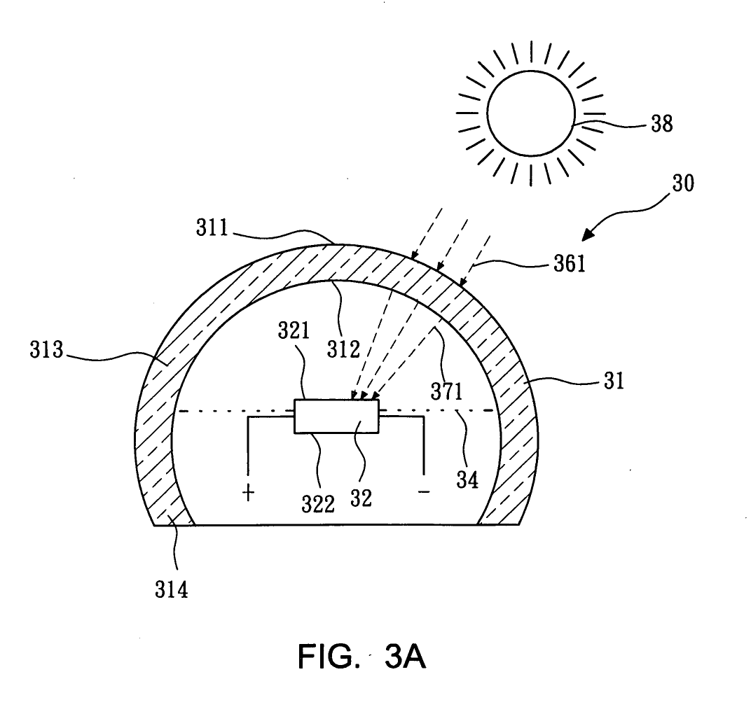

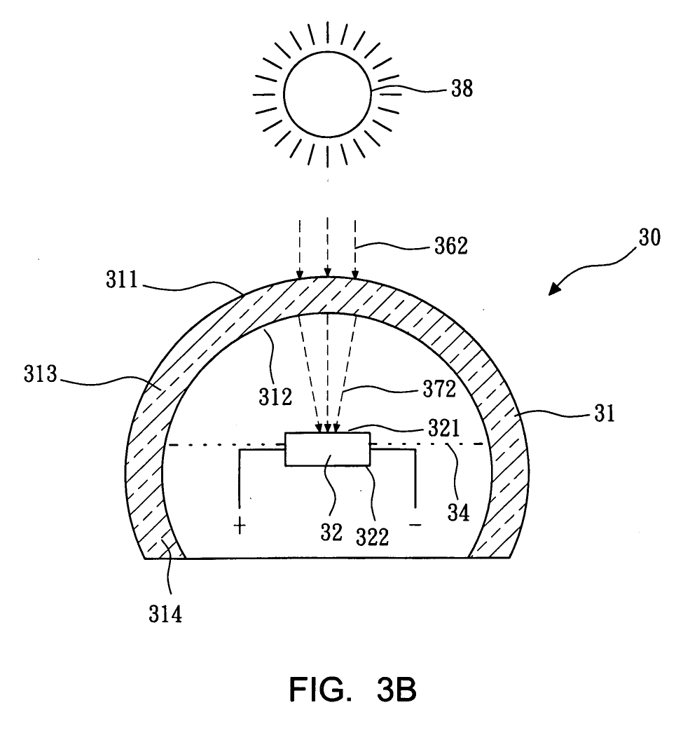

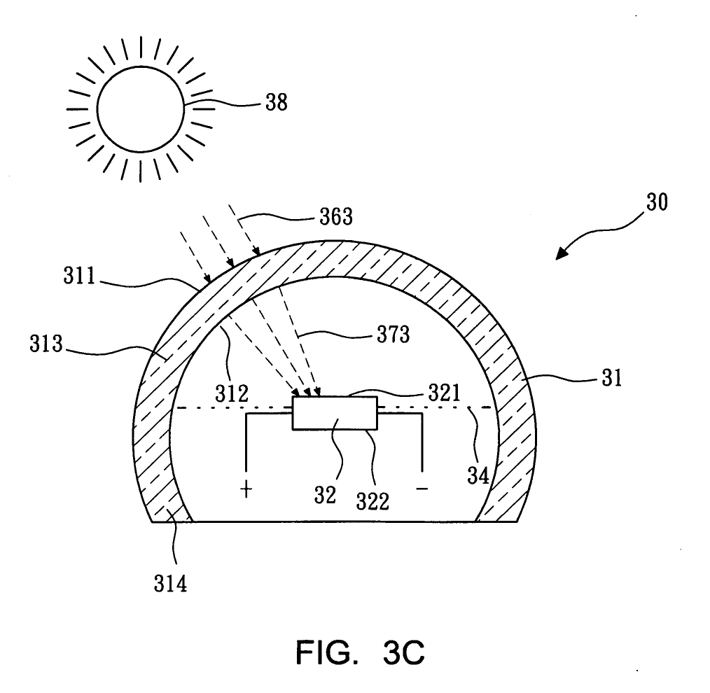

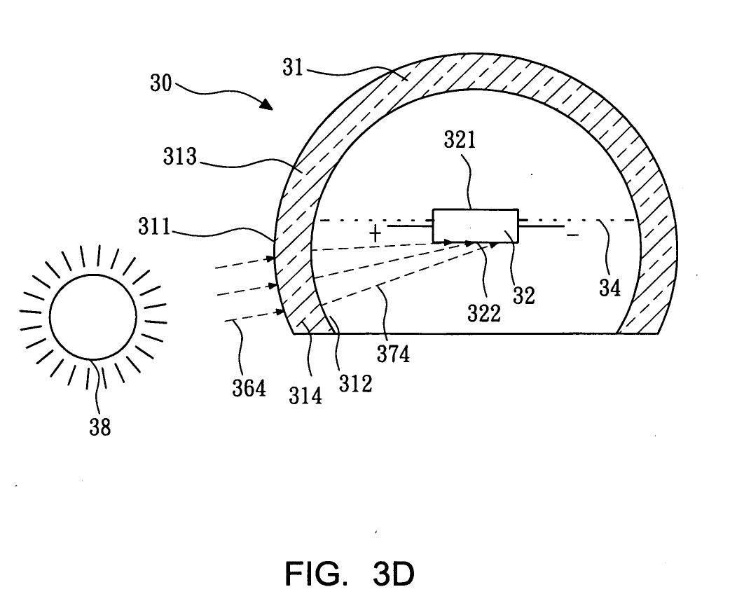

Referring to FIGS. 3A to 3D, they show a solar energy system with spherical lens, according to a first embodiment of the invention. The solar energy system 30 comprises: a spherical lens 31 and a solar energy plate 32. The spherical lens 31 has a first surface 311 and a second surface 312. The first surface 311 is used for receiving incident light from a light source at any location. The second surface 312 is used for transmitting concentrated light caused by the incident light to a predetermined region. In the first embodiment, the light source is the sun 38.

Referring to FIG. 3A, the sun 38 moves to the right side of the solar energy system 30. The first surface 311 of the spherical lens 31 receives incident light 361 from the sun 38 at a first location (right side). The second surface 312 of the spherical lens 31 transmits concentrated light 371 caused by the incident light 361 to the solar energy plate 32. The solar energy plate 32 is mounted on the predetermined region, and is used for receiving the concentrated light 371 and generating electrical energy.

Referring to FIG. 3B, the sun 38 moves to the directly above position of the solar energy system 30. The first surface 311 of the spherical lens 31 receives incident light 362 from the sun 38 at a second location (directly above position). The second surface 312 of the spherical lens 31 transmits concentrated light 372 caused by the incident light 362 to the solar energy plate 32. The solar energy plate 32 is still on the predetermined region, and can receive the concentrated light 372.

Referring to FIG. 3C, the sun 38 moves to the left side of the solar energy system 30. The first surface 311 of the spherical lens 31 receives incident light 363 from the sun 38 at a third location (left side). The second surface 312 of the spherical lens 31 transmits concentrated light 373 caused by the incident light 363 to the solar energy plate 32. The solar energy plate 32 is still on the predetermined region, and can receive the concentrated light 373.

Because the spherical lens 31 is formed as a spherical shape, the spherical lens can receive the incident light from any location and transmit the concentrated light to the same predetermined region. The solar energy system 30 of the invention does not need to be driven to move following the sun 38, and does not need any other electrical consumption. The solar energy plate 32 on the predetermined region can always receive the concentrated light from the spherical lens 31. Therefore, the efficiency of the solar energy system 30 of the invention is high.

Referring to FIGS. 3A to 3D, the solar energy plate 32 comprises a first receiving surface 321 and a second receiving surface 322. The first receiving surface 321 and the second receiving surface 322 can receive the concentrated light from the spherical lens 31. The second receiving surface 322 is corresponding to the first receiving surface 321. Corresponding to a predetermined level 34, the first receiving surface 321 faces upwardly and the second receiving surface 322 faces downwardly.

The spherical lens 31 further comprises a semi-spherical portion 313 and an extending portion 314. The semi-spherical portion 313 is disposed above the predetermined level 34, and the extending portion 314 is disposed below the predetermined level 34. The first receiving surface 321 of the solar energy plate 32 receives the concentrated light from the semi-spherical portion 313 of the spherical lens 31, as shown in FIGS. 3A to 3C. The second receiving surface 322 of the solar energy plate 32 receives the concentrated light from the extending portion 314, as shown in FIG. 3D. According to the invention, the spherical lens does not limit to have both the semi-spherical portion and the extending portion, and the spherical lens may only have the semi-spherical portion without the extending portion.

Referring to FIG. 3D, the sun 38 moves below the predetermined level 34. The first surface 311 of the spherical lens 31 receives incident light 364 from the sun 38 at a fourth location (below the predetermined level 34). The second surface 312 of the spherical lens 31 transmits concentrated light 374 caused by the incident light 364 to the second receiving surface 322 of the solar energy plate 32. Because of the two receiving surfaces 321 and 322, the solar energy plate 32 can receive more concentrated light. Therefore, the efficiency of the solar energy system 30 of the invention can be improved further.

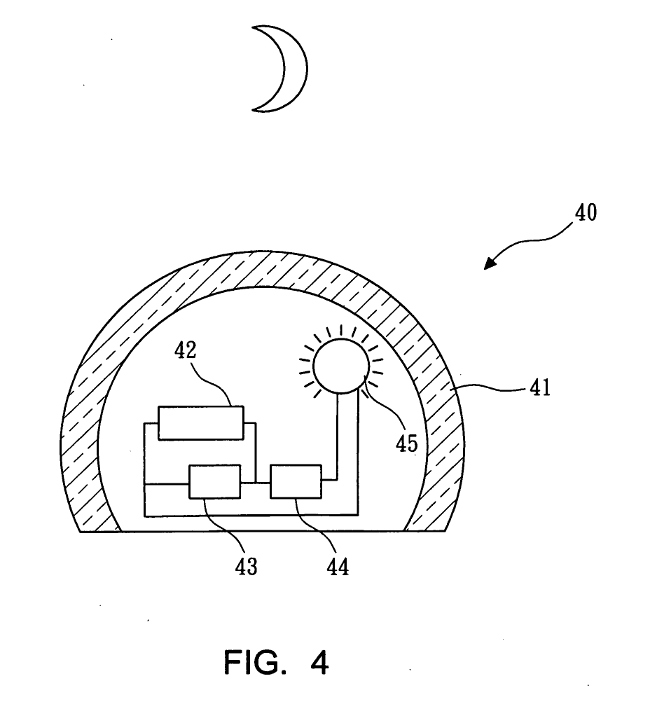

Referring to FIG. 4, it shows a solar energy system with spherical lens, according to a second embodiment of the invention. The solar energy system 40 comprises: a spherical lens 41, a solar energy plate 42, an energy storage device 43, a control device 44 and a light emitting device 45. The spherical lens 41 and the solar energy plate 42 of the second embodiment are the same as the spherical lens 31 and the solar energy plate 32 of the first embodiment. The energy storage device 43 is used for storing the electrical energy from the solar energy plate 42. The light emitting device 45 is used for receiving the electrical energy from the solar energy plate 42 or the energy storage device 43 and generating light on the night or cloudy day. The control device 44 is used for controlling whether the electrical energy outputs to the light emitting device 45. Therefore, the solar energy system 40 may be used as a street lamp for saving power and having aesthetic stereoscopic effect.

While several embodiments of the present invention have been illustrated and described, various modifications and improvements can be made by those skilled in the art. The embodiment of the present invention is therefore described in an illustrative, but not restrictive, sense. It is intended that the present invention may not be limited to the particular forms as illustrated, and that all modifications which maintain the spirit and scope of the present invention are within the scope as defined in the appended claims.

What is claimed is:

1. A solar energy system with spherical lens, the solar energy system comprising:
a spherical lens, having a first surface and a second surface, the first surface for receiving incident light from a light source at any location, the second surface for transmitting concentrated light caused by the incident light to a predetermined region; and
a solar energy plate, mounted on the predetermined region, for receiving the concentrated light and generating electrical energy.

2. The solar energy system according to claim 1, wherein the spherical lens is a semi-spherical lens.

3. The solar energy system according to claim 1, wherein the solar energy plate comprises a first receiving surface and a second receiving surface for receiving the concentrated light, the second receiving surface corresponding to the first receiving surface, corresponding to a predetermined level the first receiving surface facing upwardly and the second receiving surface facing downwardly.

4. The solar energy system according to claim 3, wherein the spherical lens further comprises a semi-spherical portion and an extending portion, the semi-spherical portion disposed above the predetermined level, the extending portion disposed below the predetermined level.

5. The solar energy system according to claim 4, wherein the first receiving surface receives the concentrated light from the semi-spherical portion and the second receiving surface receives the concentrated light from the extending portion.

6. The solar energy system according to claim 1, further comprising an energy storage device for storing the electrical energy.

7. The solar energy system according to claim 1, further comprising a light emitting device for receiving the electrical energy and generating light.

8. The solar energy system according to claim 7, further comprising a control device for controlling the electrical energy to the light emitting device.
